(19) United States
(12) Patent Application Publication
(10) Pub. No.: US 2026/0351230 A1
(43) Pub. Date: Nov. 5, 2026

(54) ACTIVE NOISE CONTROL METHOD, ACTIVE NOISE CONTROL APPARATUS, AND PROGRAM

(71) Applicant: NIPPON TELEGRAPH AND TELEPHONE CORPORATION, Tokyo (JP)

(72) Inventors: Shin MURATA, Musashino-shi, Tokyo (JP); Noriyoshi KAMADO, Musashino-shi, Tokyo (JP); Hiroaki ITO, Musashino-shi, Tokyo (JP)

(73) Assignee: NIPPON TELEGRAPH AND TELEPHONE CORPORATION, Tokyo (JP)

(21) Appl. No.: 19/099,862

(22) PCT Filed: Aug. 29, 2022
(86) PCT No.: PCT/JP2022/032366

§ 371 Date: Jan. 30, 2025

(51) Int. Cl. G10K 11/178

(52) U.S. Cl. CPC G10K 11/17817; G10K 11/17815; G10K 11/17823; G10K 11/17825; G10K 11/17881; G10K 2210/3022; G10K 2210/3026; G10K 2210/3027; G10K 2210/3028; G10K 2210/3038; G10K 2210/3047

(57) ABSTRACT

A reference microphone detects noise x(n) from a noise source N. A noise prediction unit predicts noise (noise x′(n)) that propagates through a primary path P and reaches a specific position Z by using the noise x(n) as an input. A noise control filter generates a cancellation sound y(n) by using the noise x′(n) and a coefficient K. A secondary sound source emits the cancellation sound y(n). A secondary path model estimates noise (noise x″(n)) that propagates through a secondary path S and reaches the specific position Z by using the noise x′(n) as an input. An error microphone detects an interference sound e(n) configured by noise d(n) and noise d′(n). A coefficient update unit updates the coefficient K by using the estimated noise x″(n) and the interference sound e(n) as an input.

### TECHNICAL FIELD

The present disclosure relates to an active noise control technique.

### BACKGROUND ART

An active noise control (ANC) apparatus is an apparatus that attenuates noise at a specific position by adding, to the noise at the specific position, sound having an opposite phase to the phase of the noise at the specific position. In many cases, the active noise control apparatus includes a microphone that measures an attenuation amount of noise and is called an error microphone, a speaker that generates sound (a cancellation sound for noise control) that cancels out noise called a secondary sound source, and a noise control filter that estimates the canceling sound. In addition to the above-described configuration, a configuration including a reference microphone that is installed at a place different from the place of the error microphone and records noise is generally used. The noise control filters include a noise control filter that is fixed and not changed during an operation of active noise control, and a noise control filter that is adaptively updated by a coefficient update unit based on a result of noise suppression and the like.

### CITATION LIST

### Non Patent Literature

Non Patent Literature 1: Yoshinobu KAJIKAWA, “Active noise control no saikin no wadai to ouyou (in Japanese) (Recent topics and applications of active noise control)”, Technical Report from Special Interest Group on Music and Computer (MUS) 2015.3(2015): 1-6

### SUMMARY OF INVENTION

### Technical Problem

As disclosed in Non Patent Literature 1, active noise control is generally used for controlling noise of a low-frequency component. A passive noise control technique for physically attenuating noise, such as closing an ear with a canal type earphone, is used for controlling noise including a high-frequency component. A method using active noise control is useful in order to provide a user with a comfortable quiet space in a space such as public transportation where a layout is fixed. However, there is a problem that it is difficult to completely erase sound in all frequency bands.

An object of the present disclosure has been made in view of the technical issues described above and is to provide an active noise control method in which it is expected to improve noise control performance even in a frequency band where a suppression amount of noise is small in conventional active noise control.

### Solution to Problem

In order to solve the above problem, according to an aspect of the present disclosure, there is provided an active noise control method performed by an active noise control apparatus. A reference microphone detects noise of a noise source. A noise prediction unit predicts the detected noise that propagates through a primary path from the noise source to a specific position and reaches the specific position. A noise control filter generates a cancellation sound for noise control by using the predicted noise and a predetermined coefficient. A secondary sound source emits the generated cancellation sound. A secondary path model estimates the predicted noise that propagates through a secondary path from the secondary sound source to the specific position and reaches the specific position. An error microphone disposed at the specific position detects an interference sound between the noise of the noise source, which propagates through the primary path and reaches the specific position and the emitted cancellation sound that propagates through the secondary path and reaches the specific position. A coefficient update unit updates the predetermined coefficient used by the noise control filter, by using the estimated noise and the detected interference sound as an input.

### Advantageous Effects of Invention

According to the present disclosure, since the noise control filter can be notified of noise prediction of a noise source at an early timing, it is expected to improve the noise control performance even in a frequency band where the amount of noise suppressed in conventional active noise control is small.

### BRIEF DESCRIPTION OF DRAWINGS

FIG. 1 is a diagram illustrating a functional configuration of an active noise control apparatus according to the present embodiment.

FIG. 2 is a processing flowchart illustrating a processing procedure of an active noise control method according to the present embodiment.

FIG. 3 is a diagram illustrating a functional configuration of a noise prediction learning apparatus in the present embodiment.

FIG. 4 is a processing flowchart illustrating a processing procedure of a noise prediction learning method in the present embodiment.

FIG. 5 is a diagram illustrating a functional configuration of an active noise control apparatus according to a modification example of the present embodiment.

FIG. 6 is a processing flowchart illustrating a processing procedure of an active noise control method according to the modification example of the present embodiment.

FIG. 7 is a diagram illustrating a functional configuration of a computer.

### DESCRIPTION OF EMBODIMENTS

Hereinafter, an embodiment of the present disclosure will be described in detail. Note that, in the drawings, components having the same function are denoted by the same reference signs, and repetitive description will be omitted.

### Active Noise Control Apparatus

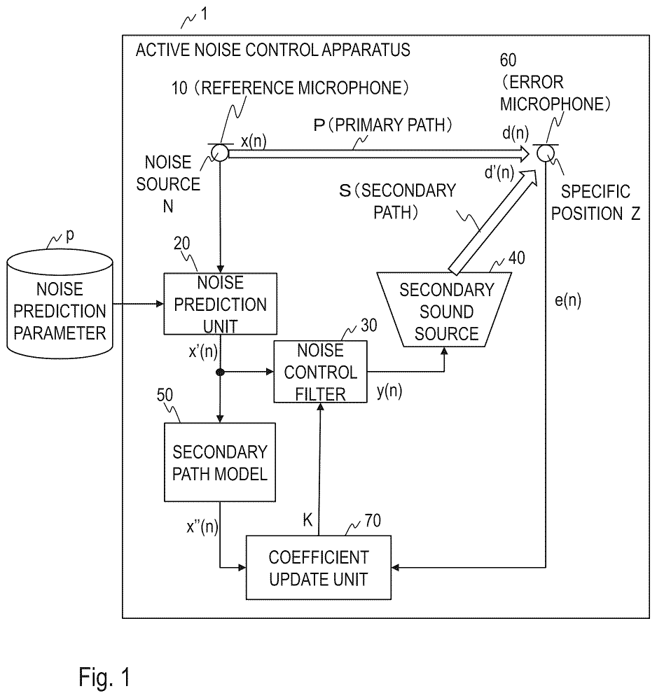

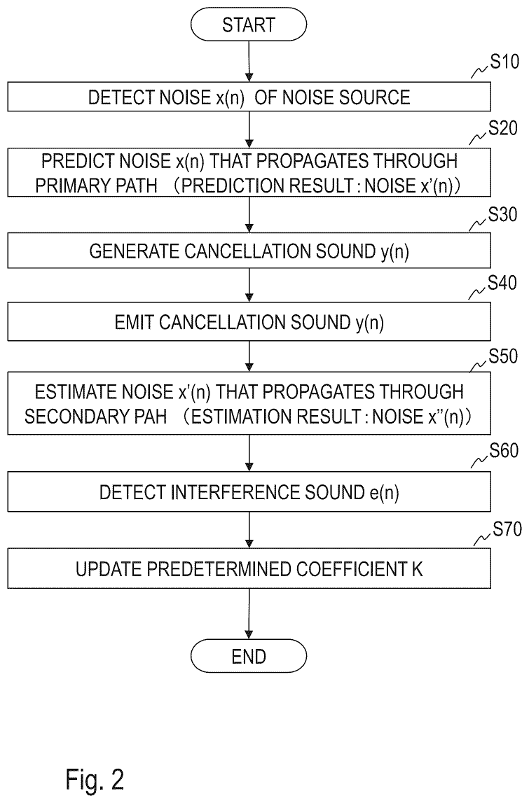

As illustrated in FIG. 1, an active noise control apparatus 1 according to the present embodiment includes a reference microphone 10, a noise prediction unit 20, a noise control filter 30, a secondary sound source 40, a secondary path model 50, an error microphone 60, and a coefficient update unit 70. The active noise control apparatus 1 executes processes of steps illustrated in FIG. 2, thereby realizing an active noise control method in the present embodiment.

A processing procedure of the active noise control method performed by the active noise control apparatus 1 in the embodiment will be described below with reference to FIGS. 1 and 2.

### Reference Microphone 10

It is assumed that noise x(n) is emitted from a noise source N in the active noise control apparatus 1 illustrated in FIG. 1. In this case, the reference microphone 10 detects the noise x(n) from the noise source N, performs necessary amplification processing (not illustrated) and analog-to-digital conversion processing (not illustrated), and then outputs the noise x(n) to the noise prediction unit 20 (step S10). In the active noise control apparatus 1 in the present disclosure, the reference microphone 10 may be provided with a vibration pickup in addition to the reference microphone 10. This is because vibrations are transmitted faster in solids than in gases, and thus there is a probability that noise can be recorded in the form of vibration earlier than a case where the noise is transmitted by sound.

Note that, in the present disclosure, it is assumed that a path from the noise source N to a specific position Z, through which the noise x(n) propagates, is referred to as a primary path P.

### Noise Prediction Unit 20

The noise prediction unit 20 predicts the noise x(n) which propagates through the primary path P, reaches the specific position Z, and is detected by the reference microphone 10. That is, the noise prediction unit 20 predicts noise d(n) of the noise source N, which propagates through the primary path P and reaches the specific position Z, by using the noise x(n) received from the reference microphone 10 as an input, and outputs noise x′(n) that is a prediction result, to the noise control filter 30 and the secondary path model 50 (step S20). For example, the noise prediction unit 20 may be configured by linear convolution, or may be configured to perform learning using a neural network technique and use a learned network (learned model) as will be described later. The configuration of the noise prediction unit 20 is determined by reception of a parameter stored in a noise prediction parameter p.

### Noise Control Filter 30

The noise control filter 30 generates a cancellation sound y(n) for noise control, by using the noise x′(n) predicted by the noise prediction unit 20 and a predetermined coefficient K. That is, the noise control filter 30 updates a coefficient (parameter) of the noise control filter 30 by using the predetermined coefficient K received from the coefficient update unit 70 as will be described later, and then, generates the cancellation sound y(n) for noise control by using the noise x′(n) that is the prediction result of the noise received from the noise prediction unit 20. Then, the noise control filter 30 outputs the cancellation sound y(n) to the secondary sound source 40 (step S30). The noise control filter 30 is, for example, a model represented by convolution of coefficients and signals.

### Secondary Sound Source 40

The secondary sound source 40 performs necessary amplification processing (not illustrated) and digital-analog conversion processing (not illustrated) on the cancellation sound y(n) received from the noise control filter 30, and then emits the cancellation sound y(n) to the error microphone 60 (step S40). Note that, in the present disclosure, it is assumed that a path from the secondary sound source 40 to the specific position Z, through which the cancellation sound y(n) propagates, is referred to as a secondary path S.

### Secondary Path Model 50

The secondary path model 50 estimates the noise x′(n) that propagates through the secondary path S, reaches the specific position Z, and is predicted by the noise prediction unit 20. That is, in order to compensate for an influence of the secondary path S, the secondary path model 50 estimates noise in a case where it is assumed that the noise x′(n) that is the prediction result received from the noise prediction unit 20 propagates through the secondary path S and reaches the specific position Z, and outputs noise X″(n) that is an estimation result, to the coefficient update unit 70 (step S50). The secondary path model 50 is, for example, a model represented by convolution of coefficients and signals.

### Error Microphone 60

The error microphone 60 is disposed at the specific position Z. The error microphone 60 detects an interference sound e(n) between the noise d(n) of the noise source N, which propagates through the primary path P and reaches the specific position Z, and noise d′(n) from the secondary sound source 40, which propagates through the secondary path S and reaches the specific position Z. That is, the error microphone 60 detects the interference sound e(n) configured by two types of noise that are the noise d(n) of the noise source, which propagates through the primary path P and reaches the specific position Z, and the noise d′(n) of the secondary sound source 40, which propagates through the secondary path S and reaches the specific position Z (noise obtained in a manner that the cancellation sound y(n) subjected to the necessary amplification processing and the digital-to-analog conversion processing propagates through the secondary path S and reaches the specific position Z). The error microphone 60 performs necessary amplification processing (not illustrated) and analog-to-digital conversion processing (not illustrated) on the interference sound e(n) and then outputs the interference sound e(n) to the coefficient update unit 70 (step S60). Note that a configuration using a virtual error microphone that spatially predicts noise in the error microphone from a recording result in another microphone instead of the error microphone 60 may be made.

### Coefficient Update Unit 70

The coefficient update unit 70 updates, to a new coefficient K, the predetermined coefficient K used when the noise control filter 30 generates the cancellation sound y(n) for noise control, by using the noise X″(n) estimated by the secondary path model 50 and the interference sound e(n) detected by the error microphone 60 as an input, and outputs the updated coefficient K to the noise control filter 30 (step S70). Note that a method of updating the coefficient of the noise control filter 30 by using the secondary path model 50 and the coefficient update unit 70 corresponds to the Filtered-x algorithm disclosed in Non Patent Literature 1 described above.

The active noise control apparatus 1 has been described above. Since the active noise control apparatus 1 has the configuration described above, effects as follows are expected. That is, the secondary path model 50 and the coefficient update unit 70 compensate for the influence of the secondary path S and update the coefficient (parameter) used by the noise control filter 30. Here, it is assumed that the secondary path model 50 and the noise control filter 30 acquire the noise x′(n) that is the prediction result of the noise d(n) before the error microphone 60 detects the noise d(n). x′(n) is a result in which an influence of the primary path P is considered by the noise prediction unit 20. Thus, it is possible to generate the cancellation sound y(n) for noise control, which has a higher attenuation effect than a case where the noise prediction unit 20 is not provided. That is, according to the active noise control apparatus 1, the noise control filter 30 can be notified of the noise prediction (noise x′(n) ) of the noise x(n) of the noise source N at a timing earlier than the error microphone 60. As a result, it is expected to improve the noise control performance even in a frequency band where the amount of noise suppression is small in the conventional active noise control.

In the present disclosure, it is expected to improve the noise control performance particularly in a high frequency band. Since sound in the high frequency band has a short wavelength, when the phase of noise observed at a point of the error microphone 60 is slightly different from the phase of the cancellation sound, the sound waves do not cancel each other, and the noise cannot be suppressed. In a case where the noise prediction unit 20 is not provided, the process of generating the cancellation sound y(n) by the noise control filter 30 cannot be provided in the middle, and the noise d(n) reaches the error microphone 60 earlier than the noise d′(n), which causes performance deterioration. On the other hand, by providing the second estimation unit 20 described in the present disclosure, it is possible to predict the noise d(n) at a time point at which the noise d′(n) reaches the error microphone 60, so that performance deterioration due to not providing generation of the cancellation sound y(n) in the middle does not occur. That is, by providing the noise prediction unit 20, it is possible to predict a noise signal (noise d(n)) that is not observed but will arrive at the point of the error microphone 60 (that is, in the future) from the signal observed by the reference microphone 10.

### Noise Prediction Learning Apparatus

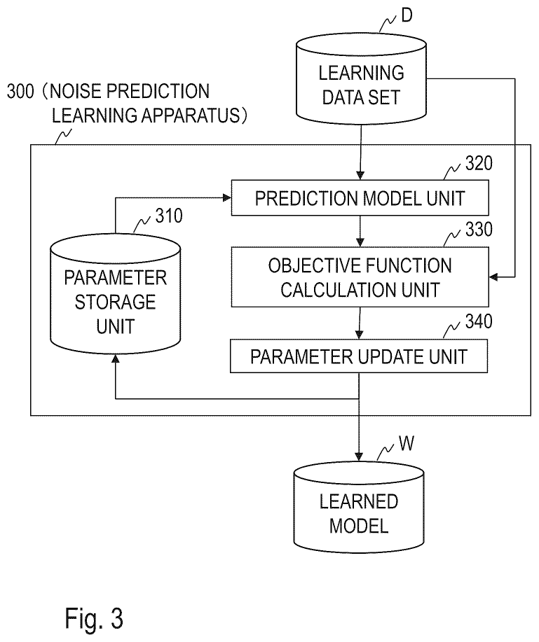

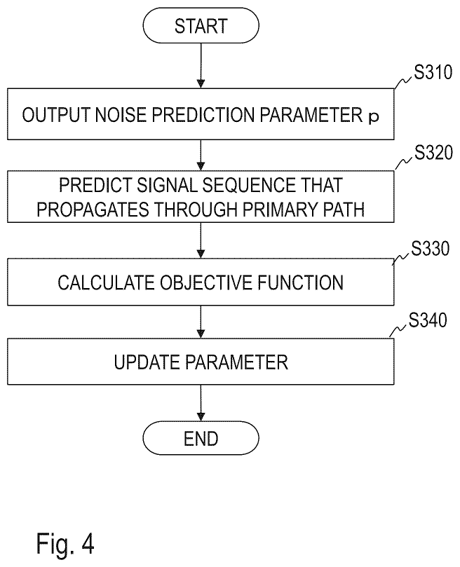

As described above, the noise prediction unit 20 may be configured to perform learning using a neural network technique and use the learned network (learned model). In a case where the noise prediction unit 20 uses a neural network in the present embodiment, the learned model may be configured to be learned by a noise prediction learning apparatus as described below. As illustrated in FIG. 3, a noise prediction learning apparatus 300 in the present disclosure includes a parameter storage unit 310, a prediction model unit 320, an objective function calculation unit 330, and a parameter update unit 340. The noise prediction learning apparatus 300 executes processes of steps illustrated in FIG. 4, thereby realizing a noise prediction learning method in the present embodiment.

A processing procedure of the noise prediction learning method performed by the noise prediction learning apparatus 300 in the present embodiment will be described below with reference to FIGS. 3 and 4.

### Parameter Storage Unit 310

In FIG. 3, the parameter storage unit 310 stores a noise prediction parameter p used by the prediction model unit 320 which will be described later, and outputs the latest noise prediction parameter p to the prediction model unit 320 (step S310).

### Prediction Model Unit 320

The prediction model unit 320 updates the own parameter by using the noise prediction parameter p received from the parameter storage unit 310, and predicts a signal sequence after the signal sequence received from a learning data set D in this state propagates through the primary path P and reaches the specific position Z. Then, the prediction model unit 320 outputs the predicted signal sequence to the objective function calculation unit 330 (step S320).

Teacher data included in the learning data set D includes, for example, K pieces of data of pairs of a sequence x(t) (also referred to below as “x_t”) of signals having a length L from a time point (t−L−1) to a time point t and a sequence x(t) (also referred to below as “y_t”) of signals having a length N from a time point (t+M) to a time point (t+M+N−1). x(t) may be a one-dimensional signal recorded from a single microphone or a multi-dimensional signal recorded by a plurality of microphones. The prediction model unit 320 receives an input of x_t described above, and outputs y′_t that is a prediction result of y_t, to the objective function calculation unit 330.

### Objective Function Calculation Unit 330

The objective function calculation unit 330 calculates an objective function by using, as an input, the signal sequence that is the prediction result received from the prediction model unit 320 and the signal sequence that is the correct data received from the learning data set D, and outputs a calculation result to the parameter update unit 340 (step S330). In the example of the data set described above, the objective function calculation unit 330 receives, as an input, the signal sequence y′_t that is the prediction result and the signal sequence y_t that is the correct data received from the learning data set, calculates a distance between the signal sequence y′_t and the signal sequence y_t by an appropriate method to calculate an objective function. Then, the objective function calculation unit 330 outputs a calculation result to the parameter update unit 340 (step S330).

### Parameter Update Unit 340

In a case where it is determined that the objective function received from the objective function calculation unit 330 does not satisfy a predetermined condition, the parameter update unit 340 updates the noise prediction parameter p and outputs the updated noise prediction parameter p to the parameter storage unit 310. For updating the parameter, for example, the parameter of the neural network is updated by using a method such as a gradient method. On the other hand, in a case where it is determined that the objective function received from the objective function calculation unit 330 satisfies the predetermined condition, the parameter update unit 340 outputs the prediction model unit having the current noise prediction parameter p as a learned model W (step S340). The learned model W is stored in the noise prediction parameter p illustrated in FIG. 1.

### Modification Example of Active Noise Control Apparatus

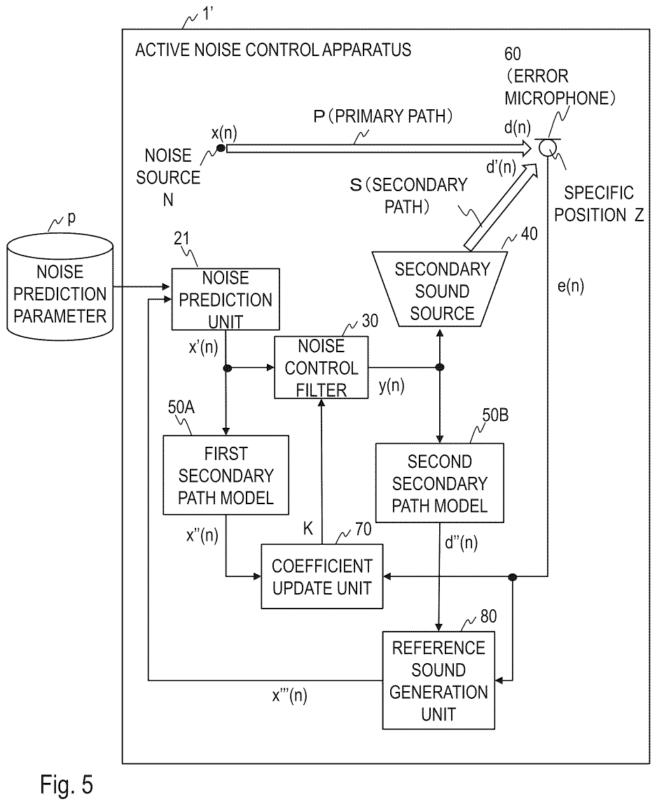

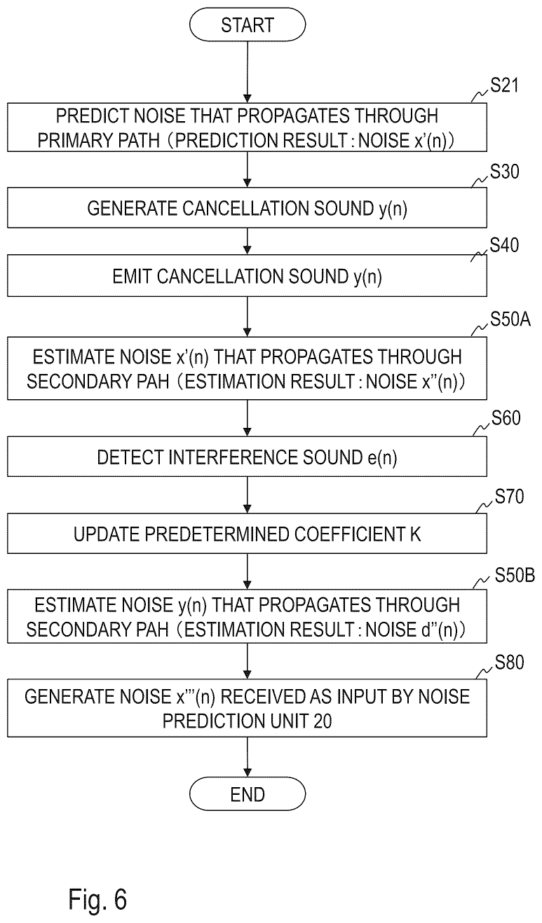

The active noise control apparatus 1 described above may be configured as a modification example of an active noise control apparatus 1′ illustrated in FIG. 5 or the like. The active noise control apparatus 1′ according to the modification example is different from the above-described active noise control apparatus 1 in the following points. In the active noise control apparatus 1′, the reference microphone 10 is no longer an essential component. Accordingly, the noise prediction unit 20 is changed to a noise prediction unit 21. The secondary path model 50 is changed to a first secondary path model 50A. A second secondary path model 50B having a function equivalent to that of the first secondary path model 50A is added. Furthermore, a reference sound generation unit 80 is newly added. The active noise control apparatus 1′ executes processes of steps illustrated in FIG. 6, thereby realizing an active noise control method according to the present modification example.

A processing procedure of the active noise control method performed by the active noise control apparatus 1′ will be described below focusing on a part different from the active noise control apparatus 1, with reference to FIGS. 5 and 6. Note that a process equivalent to the process of step S50 executed by the secondary path model 50 described above is executed in step S50A executed by the first secondary path model 50A, and thus the description thereof will be omitted.

### Noise Prediction Unit 21

The noise prediction unit 21 predicts the noise that propagates through the primary path P and reaches the specific position Z, from noise received as an input (noise x′″(n) as a reference sound which will be described later). That is, the noise prediction unit 21 predicts noise d(n) of the noise source N, which propagates through the primary path P and reaches the specific position Z, by using the noise x′″(n) received from the reference sound generation unit 80 which will be described later, as an input, and outputs noise x′(n) that is a prediction result, to the noise control filter 30 and the secondary path model 50 (step S21). For example, the noise prediction unit 20 may be configured by linear convolution, or may be configured to perform learning using a neural network technique and use a learned network (learned model) as will be described later.

### Second Secondary Path Model 50b

The second secondary path model 50B estimates the cancellation sound y(n) that propagates through the secondary path S, reaches the specific position Z, and is generated by the noise control filter 30. That is, in order to compensate for the influence of the secondary path S, the second secondary path model 50B estimates the cancellation sound y(n) to be noise that reaches the specific position Z when the noise propagates through the secondary path S, and outputs noise d″(n) that is an estimation result to the reference sound generation unit 80 (secondary path S50B).

### Reference Sound Generation Unit 80

The reference sound generation unit 80 generates the noise x′″(n) received as the input by the noise prediction unit 21, by using, as an input, the noise d″(n) estimated by the second secondary path model 50B and the interference sound e(n) detected by the error microphone 60. Here, the noise x′″(n) is noise configured by the noise d″(n), the noise d(n), and the noise d′(n). The reference sound generation unit 80 outputs the noise x′″(n) to the noise prediction unit 21 as a reference sound (corresponding to the noise x(n) in the active noise control apparatus 1). The noise prediction unit 21 executes the process of the noise prediction unit 21 by using the reference sound (noise x′″(n)) as the noise received as the input.

The modification example of the present embodiment has been described above. The active noise control apparatus 1′ according to the present modification example does not include the reference microphone 10. This makes it possible to reduce the size of the entire active noise control apparatus 1′ as compared with the active noise control apparatus 1, but the reference sound (noise x′″(n) ) input to the noise prediction unit 21 of the active noise control apparatus 1′ is delayed as compared with the noise x(n) input to the noise prediction unit 20 of the active noise control apparatus 1. However, the active noise control apparatus 1′ uses the secondary path model 50 not only to compensate for the influence of the secondary path S in the applied algorithm (the first secondary path model 50A), but also to generate the reference sound (the second secondary path model 50B). For example, in the construction of the learned model of the noise prediction unit 21, the active noise control apparatus 1′ can be expected to obtain the noise attenuation effect at the specific position to the extent comparable to the active noise control apparatus 1 by adopting the learned model obtained by performing learning in consideration of the delay in advance.

Note that, in the present modification example, the second secondary path model 50B and the reference sound generation unit 80 are added, but, for example, the error microphone 60 may have a function of switching the directivity without adding these elements. It is conceivable that the error microphone is configured to acquire the noise d(n) that is transmitted along the primary path P and arrives from the noise source N, perform appropriate amplification processing or analog-digital conversion processing on the noise d(n), and output the noise d(n) to the noise prediction unit 21. In a case where the noise prediction unit 21 adopts the neutral network technique, it is necessary to prepare a learned model learned in advance so as to conform to the above-described configuration.

While the embodiment and the modification example of the present disclosure have been described above, a specific configuration is not limited to the embodiment and the modification example, and it goes without saying that an appropriate design change or the like not departing from the gist of the present disclosure is included in the present disclosure. The various types of processing described in the embodiment and the modification example may be performed not only in chronological order in accordance with the described order, but also in parallel or individually depending on the processing capability of an apparatus that performs the processing or as necessary.

### Program and Recording Medium

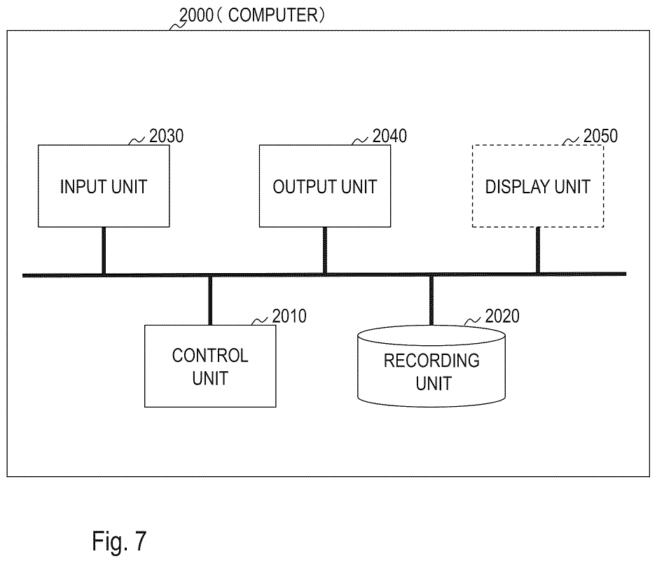

The various types of processing described above can be performed by causing a recording unit 2020 of a computer 2000 illustrated in FIG. 7 to read a program for executing each step of the method described above and causing a control unit 2010, an input unit 2030, an output unit 2040, a display unit 2050, and the like to operate.

The program in which the processing content is written may be recorded on a computer-readable recording medium. The computer-readable recording medium may be, for example, any recording medium such as a magnetic recording device, an optical disc, a magneto-optical recording medium, or a semiconductor memory.

In addition, the program is distributed by, for example, selling, transferring, or renting a portable recording medium such as a DVD or a CD-ROM on which the program is recorded. Furthermore, the program may be stored in a storage device of a server computer, and the program may be distributed by transferring the program from the server computer to another computer via a network.

For example, a computer that executes such a program first temporarily stores a program recorded on a portable recording medium or a program transferred from the server computer in a storage device of the own computer. Then, when executing processing, the computer reads the program stored in the recording medium of its own and executes the processing according to the read program. In addition, as another mode of executing the program, the computer may read the program directly from the portable recording medium and execute the processing according to the program, or may sequentially execute processing according to a received program every time the program is transferred from the server computer to the computer. In addition, the above-described processing may be executed by a so-called application service provider (ASP) type service that implements a processing function only by an execution instruction and result acquisition without transferring the program from the server computer to the computer. Note that the program in the present embodiment includes information that is used for processing by an electronic computer and is equivalent to the program (data, or the like, that is not a direct command to the computer but has property that defines processing performed by the computer).

In addition, although the present apparatus is configured by the predetermined program being executed on the computer in this mode, at least a part of the processing contents may be implemented by hardware.

1. An active noise control method performed by an active noise control apparatus, the active noise control method comprising:
detecting noise of a noise source by a reference microphone;
predicting the detected noise that propagates through a primary path from the noise source to a specific position and reaches the specific position by a noise prediction unit;
generating a cancellation sound for noise control by a noise control filter using the predicted noise and a predetermined coefficient;
emitting the generated cancellation sound by a secondary sound source;
estimating the predicted noise that propagates through a secondary path from the secondary sound source to the specific position and reaches the specific position by a secondary path model;
detecting an interference sound between the noise of the noise source that propagates through the primary path and reaches the specific position and the emitted cancellation sound that propagates through the secondary path and reaches the specific position, by an error microphone disposed at the specific position; and
updating the predetermined coefficient used by the noise control filter, by a coefficient update unit using the estimated noise and the detected interference sound as an input.

2. The active noise control method according to claim 1, wherein the noise prediction unit is configured by linear convolution.

3. The active noise control method according to claim 1, wherein the noise prediction unit is configured by a learned model trained by a neural network.

4. The active noise control method according to claim 3, wherein
the learned model has been learned by a noise prediction learning method using a noise prediction learning apparatus, and
the noise prediction learning method performed by the noise prediction learning apparatus includes
outputting a stored noise prediction parameter by a parameter storage unit,
predicting a signal sequence received by propagating through the primary path and reaching a specific position, by a prediction model unit using the output noise prediction parameter,
calculating an objective function by an objective function calculation unit using the predicted signal sequence and a signal sequence being correct data, as an input, and
by a parameter update unit, updating the noise prediction parameter stored in the parameter storage unit in a case where it is determined that the calculated objective function does not satisfy a predetermined condition, and outputting, as the learned model, the prediction model unit having a current noise prediction parameter in a case where it is determined that the calculated objective function satisfies the predetermined condition.

5. An active noise control method performed by an active noise control apparatus, the active noise control method comprising:
predicting noise that propagates through a primary path from a noise source to a specific position and reaches the specific position, from noise received as an input, by a noise prediction unit;
generating a cancellation sound for noise control by a noise control filter using the predicted noise and a predetermined coefficient;
emitting the generated cancellation sound by a secondary sound source;
estimating the predicted noise that propagates through a secondary path from the secondary sound source to the specific position and reaches the specific position by a first secondary path model;
detecting an interference sound between the noise that propagates through the primary path and reaches the specific position and the emitted cancellation sound that propagates through the secondary path and reaches the specific position by an error microphone disposed at the specific position;
updating the predetermined coefficient used by the noise control filter, by a coefficient update unit using the estimated noise and the detected interference sound as an input;
estimating the generated cancellation sound that propagates through the secondary path and reaches the specific position by a second secondary path model; and
generating the noise received as the input by the noise prediction unit, by a reference sound generation unit using the noise estimated by the second secondary path model and the interference sound detected by the error microphone as an input.

6. An active noise control apparatus comprising:
a reference microphone that detects noise from a noise source;
a noise prediction circuitry that is configured to predict predicts the detected noise that propagates through a primary path from the noise source to a specific position and reaches the specific position;
a noise control filter that generates a cancellation sound for noise control by using the predicted noise and a predetermined coefficient;
a secondary sound source that emits the generated cancellation sound;
a secondary path model that estimates the predicted noise that propagates through a secondary path from the secondary sound source to the specific position and reaches the specific position;
an error microphone that is disposed at the specific position and detects an interference sound between the noise of the noise source, which propagates through the primary path and reaches the specific position, and the emitted cancellation sound that propagates through the secondary path and reaches the specific position; and
a coefficient update circuitry that is configured to update updates the predetermined coefficient used by the noise control filter, by using the estimated noise and the detected interference sound as an input.

7. A non-transitory computer-readable recording medium on which a program for causing a computer to function as the active noise control method according to claim 1.

8. A non-transitory computer-readable recording medium on which a program for causing a computer to function as the active noise control method according to claim 2.

9. A non-transitory computer-readable recording medium on which a program for causing a computer to function as the active noise control method according to claim 3.

10. A non-transitory computer-readable recording medium on which a program for causing a computer to function as the active noise control method according to claim 4.

11. A non-transitory computer-readable recording medium on which a program for causing a computer to function as the active noise control method according to claim 5.
